(19) United States
(12) Patent Application Publication
(10) Pub. No.: US 2012/0292800 A1
(43) Pub. Date: Nov. 22, 2012

(54) PROCESS AND EQUIPMENT FOR PRODUCTION OF POLYIMIDE FILM

(75) Inventors: Yohei Higuchi, Ube-shi (JP); Yasuhiro Nagoshi, Ube-shi (JP); Takeshi Uekido, Ube-shi (JP); Toshiyuki Nishino, Ube-shi (JP); Eiji Masui, Ube-shi (JP)

(73) Assignee: UBE INDUSTRIES, LTD., Ube-shi, Yamaguchi (JP)

(21) Appl. No.: 13/575,138

(22) PCT Filed: Jan. 24, 2011
(86) PCT No.: PCT/JP2011/051232

§ 371 Date: Jul. 25, 2012

(30) Foreign Application Priority Data
Jan. 26, 2010 (JP) 2010-013752
Jan. 26, 2010 (JP) 2010-013753

(51) Int. Cl. B29C 39/44

(52) U.S. Cl. 264/40.1; 425/135

(57) ABSTRACT

Provided are a method and apparatus for the production of a polyimide film, which allow a polyimide film having physical properties with in-plane uniformity to be produced with high productivity. In the method for the production of a polyimide film, a solvent content of a self-supporting film is measured by infrared spectroscopy, and based on the measurement result, one or more kinds selected from a drying condition of a cast of a polyimide precursor solution, a post-heating condition of the self-supporting film, and an amount of extrusion of a polyimide precursor solution from a die are controlled.

### TECHNICAL FIELD

The present invention relates to a method and apparatus for the production of a polyimide film with excellent film physical properties.

### BACKGROUND ART

A polyimide film has a high heat resistance and a high electrical insulation property, and even a thin film satisfies stiffness required for handling, a heat resistance, and an electrical insulation property. Therefore, the polyimide film is widely used as an electrical insulation film, a thermal insulation film, a base film for a flexible circuit board, or the like in industrial fields.

In general, polyimide is non-meltable and is also insoluble in a solvent or the like. Therefore, a polyimide film is produced by extruding a polyimide precursor solution such as a polyamic acid solution from a tip end of a die, casting the polyimide precursor solution into a film shape on a surface of a metal support, partially drying the cast film by heating to form a self-supporting film having self-supporting property, and further post-heating the self-supporting film in a state in which the self-supporting film is peeled from the metal support or laminated on the metal support to remove a solvent, and completing imidization. The self-supporting film contracts during the post-heating, and hence heat treatment is conducted while both ends of the self-supporting film are held with holding members or the like.

A contraction degree of the self-supporting film during the post-heating varies depending on a solvent content of the self-supporting film. Therefore, a portion having a large solvent content of the self-supporting film contracts to a large extent, and a stress applied to the film becomes large, which causes variations in polyimide film physical properties and a dimensional error.

Thus, it is considered to be important to grasp the solvent content of the self-supporting film in terms of producing a polyimide film having physical properties with in-plane uniformity.

As a method of measuring a solvent content of a self-supporting film, conventionally, a solvent content has been determined by, for example, calculation with the following equation (A) or the like, based on a loss-on-heating method (see Patent Literature 1).

Solvent content={(Weight of self-supporting film−Weight of completely dried self-supporting film (Weight of dry solid))/Weight of self-supporting film}×100 (A)

Further, polyimide has small elasticity. Therefore, If a polyimide film has thickness unevenness, when the polyimide film is wound up into a roll shape, a thick portion of the film is liable to be pressurized locally, and variations in physical properties are liable to occur. Further, when metal wiring or the like is formed, there is a problem in that an adhesion defect occurs partially in a portion with thickness unevenness.

As a method of reducing thickness unevenness in a polyimide film, there has conventionally been employed a method involving measuring a thickness of a polyimide film finished product, and carrying out feedback of the measurement result to adjust a gap of a tip end of a die, for example, as described in Patent Literature 2.

Further, Patent Literature 3 below describes that thickness unevenness of a surface layer of a self-supporting film is measured, and based on the measurement result, an amount of extrusion of a polyimide precursor solution is controlled to be uniform.

### CITATION LIST

### Patent Literature

[PTL 1] JP 2005-307091 A (see paragraph [0079])
[PTL 2] JP 2001-81211 A (see paragraphs [0002] and [0013])
[PTL 3] JP 2009-241329 A (see claim 2)

### SUMMARY OF INVENTION

### Technical Problem

However, in the case where the solvent content of the self-supporting film is measured by a loss-on-heating method as described in Patent Literature 1, much time is required for the measurement, and hence it is difficult to carry out the feedback of the measurement result in real time. Further, it is necessary to measure a solvent content by sampling a plurality of measurement sites in a width direction of the self-supporting film, and hence it is difficult to measure the solvent content in line. Further, there is a problem in that, when a sample piece that is being sampled or a sampled sample piece is transferred to measurement equipment or the like, the sample piece absorbs water in the atmosphere or a solvent vaporizes from the sample piece to the atmosphere, whereby an error of measurement precision occurs easily.

Further, in a method involving adjusting a gap of a tip end of a die by carrying out feedback of a thickness of a polyimide film finished product as described in Patent Literature 2, it takes a long period of time from a time when thickness unevenness of a polyimide film is detected to a time when the feed-back result is reflected. Thus, there is a problem in that an amount of a product to be wasted increases.

Further, an imidization ratio, a solvent content, and the like of the self-supporting film are not necessarily uniform. Therefore, even when an amount of extrusion of a polyimide precursor solution is adjusted by carrying out the feedback of the measurement result of the thickness of the self-supporting film as disclosed in Patent Literature 3, thickness unevenness of the polyimide film is not always suppressed.

Accordingly, it is an object of the present invention to provide a method and apparatus for the production of a polyimide film, which allow a polyimide film having physical properties with in-plane uniformity to be produced with high productivity.

### Solution to Problem

In order to achieve the object, according to one embodiment of the present invention, there is provided a method for the production of a polyimide film, the method including: extruding a polyimide precursor solution containing a polyimide precursor and a solvent from a tip end of a die; casting the polyimide precursor solution onto a surface of a metal support to form a cast of the polyimide precursor solution; drying the cast of the polyimide precursor solution to form a self-supporting film having self-supporting property; and post-heating the self-supporting film,

in which a solvent content of the self-supporting film before the post-heating is measured by infrared spectroscopy, and based on the measurement result, one or more kinds selected from a drying condition of the cast of the polyimide precursor solution, a post-heating condition of the self-supporting film, and an amount of extrusion of the polyimide precursor solution from the die are controlled.

In the method for the production of a polyimide film according to the present invention, it is preferred that, based on the measurement result, regarding a portion having a higher solvent content in a width direction of the self-supporting film than a predetermined solvent content, a temperature and/or an amount of supply of a drying medium for drying a cast portion corresponding to the portion having the higher solvent content in the step of drying the cast of the polyimide precursor solution be increased, and

regarding a portion having a lower solvent content in a width direction of the self-supporting film than a predetermined solvent content, a temperature and/or an amount of supply of a drying medium for drying a cast portion corresponding to the portion having the lower solvent content in the step of drying the cast of the polyimide precursor solution be decreased.

In the method for the production of a polyimide film according to the present invention, it is preferred that, based on the measurement result, regarding a portion having a higher solvent content in a width direction of the self-supporting film than a predetermined solvent content, a temperature and/or an amount of supply of a heating medium for heating the portion having the higher solvent content in the post-heating step be increased, and

regarding a portion having a lower solvent content in a width direction of a self-supporting film than a predetermined solvent content, a temperature and/or an amount of supply of a heating medium for heating the portion having the lower solvent content in the post-heating step be decreased.

In the method for the production of a polyimide film according to the present invention, it is preferred that the tip end of the die include a plurality of extrusion amount adjustment mechanisms in a width direction,

based on the measurement result, regarding a portion having a higher solvent content in a width direction of the self-supporting film than a predetermined solvent content, an amount of extrusion from a die portion corresponding to the portion having the higher solvent content in the step of extruding the polyimide precursor solution from the tip end of the die be decreased, and

regarding a portion having a lower solvent content in a width direction of the self-supporting film than a predetermined solvent content, an amount of extrusion from a die portion corresponding to the portion having the lower solvent content in the step of extruding the polyimide precursor solution from the tip end of the die be increased.

In the method for the production of a polyimide film according to the present invention, it is preferred that the solvent content of the self-supporting film be measured with measurement means capable of measuring the solvent content at a plurality of points in the width direction of the self-supporting film by allowing a measurement mechanism by infrared spectroscopy to scan the self-supporting film.

In the method for the production of a polyimide film according to the present invention, it is preferred that the solvent content of the self-supporting film be determined with the following equations (1) to (3) from ratios of absorbances obtained in the case of selecting a wavelength (λ2) having an absorption peak in the solvent and having no absorption peak in the polyimide film, a wavelength (λ5) having no absorption peak in the solvent and having an absorption peak in the polyimide film, and a wavelength (λ1) having no absorption peak in any one of the solvent and the polyimide film, and irradiating the self-supporting film to be measured with infrared rays having the wavelengths.

Polymer amount=Absorbance at λ5/Absorbance at λ1 (1)

Solvent amount=Absorbance at λ2/Absorbance at λ1 (2)

Solvent content=Solvent amount/(Solvent amount+polymer amount) (3)

The method for the production of a polyimide film according to the present invention preferably further includes measuring a thickness of the cast of the polyimide precursor solution before the drying, and controlling, based on the measurement result, an amount of extrusion of the polyimide precursor solution from the die so that a thickness in a width direction of the cast becomes substantially uniform.

In the method for the production of a polyimide film according to the present invention, it is preferred that the measuring of the thickness of the cast of the polyimide precursor solution be carried out by a confocal method using laser light or a spectral interference method using a superluminescent diode.

According to another embodiment of the present invention, there is provided an apparatus for the production of a polyimide film, the apparatus including: an extrusion device for extruding a polyimide precursor solution from a tip end of a die, and casting the polyimide precursor solution onto a surface of a metal support to form a cast of the polyimide precursor solution; a drying device for drying the cast of the polyimide precursor solution to form a self-supporting film having self-supporting property; and a heating device for post-heating the self-supporting film, in which the apparatus includes: a solvent content measurement means for measuring a solvent content of the self-supporting film by infrared spectroscopy; and a control device for controlling, based on the measurement result, one or more kinds selected from a drying condition of the drying device, a heating condition of the heating device, and an extrusion condition of the extrusion device.

In the apparatus for the production of a polyimide film according to the present invention, it is preferred that the control device control, regarding a portion having a higher solvent content in a width direction of the self-supporting film than a predetermined solvent content, a temperature and/or an amount of supply of a drying medium for drying a cast portion corresponding to the portion having the higher solvent content in the drying device so as to increase the temperature and/or the amount of supply, and
the control device control, regarding a portion having a lower solvent content in a width direction of the self-supporting film than a predetermined solvent content, a temperature and/or an amount of supply of a drying medium for drying a cast portion corresponding to the portion having the lower solvent content in the drying device so as to decrease the temperature and/or the amount of supply.

In the apparatus for the production of a polyimide film according to the present invention, it is preferred that the control device control, regarding a portion having a higher solvent content in a width direction of the self-supporting film than a predetermined solvent content, a temperature and/or an amount of supply of a heating medium for heating the portion having the higher solvent content in the heating device so as to increase the temperature and/or the amount of supply, and

the control device control, regarding a portion having a lower solvent content in a width direction of the self-supporting film than a predetermined solvent content, a temperature and/or an amount of supply of a heating medium for heating the portion having the lower solvent content in the heating device so as to decrease the temperature and/or the amount of supply.

In the apparatus for the production of a polyimide film according to the present invention, it is preferred that the control device control, regarding a portion having a higher solvent content in a width direction of the self-supporting film than a predetermined solvent content, an amount of extrusion of the polyimide precursor solution from a die portion corresponding to the portion having the higher solvent content in the extrusion device so as to decrease the amount of extrusion, and

the control device control, regarding a portion having a lower solvent content in a width direction of the self-supporting film than a predetermined solvent content, an amount of extrusion of the polyimide precursor solution from a die portion corresponding to the portion having the lower solvent content in the extrusion device so as to increase the amount of extrusion.

The apparatus for the production of a polyimide film according to the present invention preferably further includes thickness measurement means for measuring a thickness of the cast of the polyimide precursor solution, in which the extrusion condition of the extrusion device is also controlled based on the measurement result of the thickness measurement means.

### Advantageous Effects of Invention

According to the method or apparatus for the production of a polyimide film according to the present invention, the solvent content of the self-supporting film is measured by infrared spectroscopy. Hence, a facility can be in-lined, and the solvent content can be measured with good precision. Further, the solvent content can be measured in a short period of time, and hence the feedback of the measurement result can be carried-out substantially in real time. In addition, one or more kinds selected from the drying condition of the cast of the polyimide precursor solution, the post-heating condition of the self-supporting film, and the amount of extrusion of the polyimide precursor solution from the die can be controlled substantially in real time, based on the solvent content of the self-supporting film. Therefore, a polyimide film having physical properties with in-plane uniformity can be produced with high productivity, while preventing the generation of a defective product.

Further, according to the embodiment of the present invention in which the thickness of the cast of the polyimide precursor solution before the drying is measured, and based on the measurement result the amount of extrusion of the polyimide precursor solution from the die is controlled so that the thickness in a width direction of the cast becomes uniform, the cause of the thickness unevenness of the polyimide film can be found in an early stage, and the feedback result can be reflected in an early stage. Therefore, the amount of a product to be wasted is reduced, and a polyimide film having less thickness unevenness can be produced with high productivity.

### BRIEF DESCRIPTION OF DRAWINGS

FIG. 1 A schematic structural view of an apparatus for the production of a polyimide film according to the present invention.

FIG. 2 A graphic chart showing spectral characteristics obtained when N,N-dimethylacetamide used as a solvent in an embodiment of the present invention and a polyimide film are each irradiated with infrared rays.

FIG. 3 A flow chart illustrating a first aspect of a control device in the apparatus for the production of a polyimide film of the present invention.

FIG. 4 A flow chart illustrating a second aspect of the control device in the apparatus for the production of a polyimide film of the present invention.

FIG. 5 A flow chart illustrating a third aspect of the control device in the apparatus for the production of a polyimide film of the present invention.

FIG. 6 A view illustrating a measurement principle of a confocal method used in an embodiment of the present invention.

FIG. 7 A view illustrating a measurement principle of a spectral interference method used in an embodiment of the present invention.

FIG. 8 A flow chart illustrating a fourth aspect of the control device in the apparatus for the production of a polyimide film of the present invention.

FIG. 9 A view illustrating relationships between measurement points of a self-supporting film measured for a solvent content in the present invention and regions corresponding to the measurement points in steps.

FIG. 10 A graphic chart showing results obtained by comparing the measurement of a solvent content by infrared spectroscopy (IR) in the present invention with the measurement of a solvent content by a loss-on-heating method.

### DESCRIPTION OF EMBODIMENTS

A method for the production of a polyimide film according to the present invention mainly includes: a cast polyimide precursor formation step including forming a cast of a polyimide precursor solution (hereinafter, referred to as “cast polyimide precursor”) by extruding a polyimide precursor solution containing a polyimide precursor and a solvent from a tip end of a die, and casting the solution onto the surface of a metal support; a self-supporting film formation step of forming a self-supporting film having self-supporting property by drying the cast polyimide precursor; and a post-heating step of post-heating the self-supporting film.

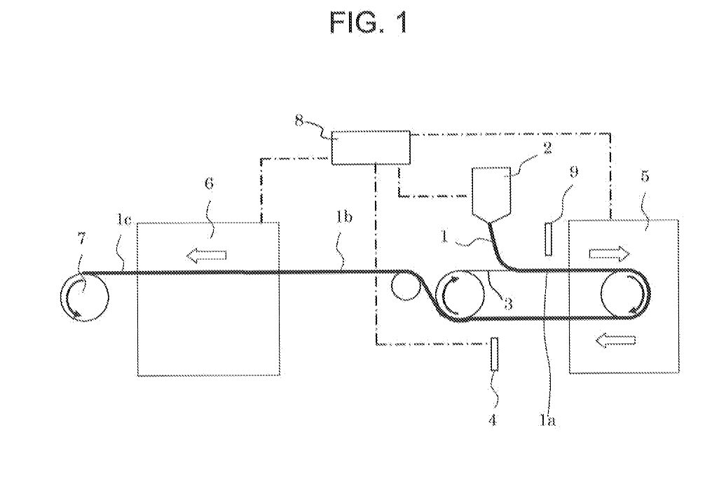

Hereinafter, one embodiment of the method for the production of a polyimide film according to the present invention is described with reference to FIG. 1.

FIG. 1 illustrates a schematic structural view of an apparatus for the production of a polyimide film according to the present invention. The apparatus for the production of a polyimide film includes an extrusion device for extruding a polyimide precursor solution 1 from a tip end of a die 2, and casting the solution onto a metal belt 3 to form a cast polyimide precursor 1a. In other words, in this embodiment, the die 2 constitutes the extrusion device in the present invention.

A drying furnace 5 is provided on a conveying path of the metal belt 3, and in the drying furnace 5, the cast polyimide precursor is dried to form a self-supporting film 1b having self-supporting property. In this embodiment, the drying furnace 5 constitutes a drying device in the present invention.

Further, the self-supporting film 1b is peeled from the metal belt 3 to be fed to a heating furnace 6. Then, in the heating furnace 6, the post-heating step of heating the self-supporting film to remove a solvent and complete imidization is performed. In this embodiment, the heating furnace 6 constitutes a heating device in the present invention.

Further, there is provided a take-up device 7 for taking up a polyimide film 1c after being subjected to the post-heating step.

In addition, the apparatus for the production of a polyimide film according to the present invention includes solvent content measurement means 4 for measuring a solvent content of the self-supporting film 1b by infrared spectroscopy, and a control device 8 for controlling one or more kinds selected from the drying condition of the drying device 5, the heating condition of the heating device 6, and the extrusion condition of the extrusion device, based on the measurement result.

The method for the production of a polyimide film according to the present invention mainly includes: a cast polyimide precursor formation step of forming the cast polyimide precursor 1a by casting the polyimide precursor solution 1 onto the metal belt 3 by the extrusion device; a self-supporting film formation step of forming the self-supporting film 1b having self-supporting property by drying the cast polyimide precursor 1a by the drying furnace 5; and a post-heating step of post-heating the self-supporting film 1b by the heating furnace 6 to remove a solvent and complete imidization, for example, through use of the above-mentioned production apparatus. Hereinafter, each step is described in detail.

(Cast Polyimide Precursor Formation Step)

In the cast polyimide precursor formation step, the polyimide precursor solution 1 is extruded from the tip end of the die 2 and cast onto the metal belt 3 to form the cast polyimide precursor. 1a. In this embodiment, the metal belt 3 corresponds to the metal support in the present invention. More specifically, one kind or a plurality of kinds of the polyimide precursor solution 1 is extruded from a discharge port (lip portion) of the die 2 onto the metal belt 3 as a single layer or a multilayer of a thin film through use of a film formation device in which a die for forming a single layer or a multilayer by extrusion is provided, and the cast polyimide precursor 1a is formed as a thin film of a solvent solution of a polyimide precursor.

Examples of the polyimide precursor solution may include a solution of a polyamic acid, a polyamic acid salt, a polyamic acid alkyl ester, or a polyamic acid trimethylsilyl ester, a mixed solution of a tetracarboxylic acid diester and a diamine, and a solution which includes two or more kinds of those.

The polyamic acid solution that is a polyimide precursor solution may be obtained by reacting a tetracaborxylic acid component with a diamine component by a known method. For example, the polyamic acid solution may be produced by polymerizing a tetracarboxylic acid component with a diamine component in an organic solvent generally used for the production of polyimide.

Examples of the tetracarboxylic acid component may include an aromatic tetracarboxylic acid dianhydride, an aliphatic tetracarboxylic acid dianhydride, and an alicyclic tetracarboxylic acid dianhydride. Specific examples thereof include aromatic tetracarboxylic acid dianhydrides such as 3,3′,4,4′-biphenyltetracarboxylic acid dianhydride (hereinafter, sometimes referred to as “s-BPDA”), pyromellitic acid dianhydride

(hereinafter, sometimes referred to as “PMDA”), 3,3′,4,4′-oxydiphthalic acid dianhydride, diphenylsulfone-3,4,3′,4′-tetracarboxylic acid dianhydride, bis(3,4-dicarboxyphenyl)sulfide dianhydride, and 2,2-bis(3,4-dicarboxyphenyl)-1,1,1,3,3,3-hexafluoropropane dianhydride.

Examples of the diamine component may include an aromatic diamine, an aliphatic diamine, and an alicyclic diamine. Specific examples thereof include aromatic diamines such as p-phenylenediamine (hereinafter, sometimes referred to as “PPD”), 4,4′-diaminodiphenyl ether (hereinafter, sometimes referred to as “DADE”), 3,4′-diaminodiphenyl ether, m-tolidine, p-tolidine, 5-amino-2-(p-aminophenyl)benzoxazole, 4,4′-diaminobenzanilide, 1,3-bis(4-aminophenoxy)benzene, 1,4-bis(3-aminophenoxy)benzene, 1,4-bis(4-aminophenoxy)benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, 2,2-bis[3-(3-aminophenoxy)phenyl]propane, 2,2-bis[3-(4-aminophenoxy)phenyl]propane, 2,2-bis[4-(3-aminophenoxy)phenyl]propane, and 2,2-bis[4-(4-aminophenoxy)phenyl]propane.

As examples of a combination of the tetracarboxylic acid component and the diamine component, combinations 1) to 3) below are given in view of mechanical characteristics and a heat resistance.

1) A combination of 3,3′,4,4′-biphenyltetracarboxylic acid dianhydride and p-phenylenediamine, or a combination of 3,3′,4,4′-biphenyltetracarboxylic acid dianhydride, and p-phenylenediamine and 4,4-diaminodiphenyl ether (for example, PPD/DADE (molar ratio) is preferably 100/0 to 85/15).

2) A combination of 3,3′,4,4′-biphenyltetracarboxylic acid dianhydride and pyromellitic acid dianhydride (for example, s-BPDA/PMDA (molar ratio) is preferably 0/100 to 90/10), and p-phenylenediamine, or a combination of 3,3′,4,4′-biphenyltetracarboxylic acid dianhydride and pyromellitic acid dianhydride, and p-phenylenediamine and 4,4-diaminodiphenyl ether (for example, PPD/DADE (molar ratio) is preferably 90/10 to 10/90).

3) A combination of pyromellitic acid dianhydride, and p-phenylenediamine and 4,4-diaminodiphenyl ether (for example, PPD/DADE (molar ratio) is preferably 90/10 to 10/90).

As the organic solvent, a known solvent may be used, and examples thereof include N-methyl-2-pyrrolidone, N,N-dimethylformamide, N,N-dimethylacetamide, and N,N-diethylacetamide. These organic solvents may be used alone or in combination of two or more kinds thereof. Of those, N,N-dimethylacetamide is preferably used.

The present invention may be applied to the case of forming a polyimide film by any one mode of thermal imidization, which is conducted thermally, and chemical imidization, which is conducted chemically. Of those, the present invention may be preferably applied to thermal imidization, whose imidization rate is lower than that of chemical imidization.

In the case of completing imidization by subjecting a polyimide precursor solution to thermal imidization, an imidization catalyst, an organic phosphorus-containing compound, inorganic fine particles, and the like may be added to a polyamic acid solution, if required.

In the case of completing imidization by subjecting a polyimide precursor solution to chemical imidization, a cyclization catalyst, a dehydrating agent, inorganic fine particles, and the like may be added to a polyamic acid solution, if required.

Examples of the imidization catalyst include a substituted or unsubstituted nitrogen-containing heterocyclic compound, an N-oxide compound of the nitrogen-containing heterocyclic compound, a substituted or unsubstituted amino acid compound, and an aromatic hydrocarbon or aromatic heterocyclic compound having a hydroxyl group.

Examples of the cyclization catalyst include an aliphatic tertiary amine, an aromatic tertiary amine, and a heterocyclic tertiary amine.

Examples of the dehydrating agent include an aliphatic carboxylic acid anhydride and an aromatic carboxylic acid anhydride.

Examples of the inorganic fine particles may include particulate inorganic oxide powders such as titanium dioxide powder, silicon dioxide (silica) powder, magnesium oxide powder, aluminum oxide (alumina) powder, and zinc oxide powder, particulate inorganic nitride powders such as silicon nitride powder and titanium nitride powder, inorganic carbide powders such as silicon carbide powder, and particulate inorganic salt powders such as calcium carbonate powder, calcium sulfate powder, and barium sulfate powder. Two or more kinds of these inorganic fine particles may be used in combination. In order to disperse these inorganic fine particles uniformly, means known per se may be applied.

There is no particular limitation on the solid content concentration (polymer component) of the polyimide precursor solution, as long as the solid content concentration falls in a viscosity range suitable for the production of a film by casting. The solid content concentration is preferably 10% by mass to 30% by mass, more preferably 15% by mass to 27% by mass, still more preferably 16% by mass to 24% by mass.

(Self-Supporting Film Formation Step)

In the self-supporting film formation step, the cast polyimide precursor 1a formed on the metal belt 3 as described above is introduced into the drying furnace 5 so as to be dried through heat treatment to form the self-supporting film 1b having self-supporting property. Herein, drying refers to an operation of heating the polyimide precursor solution to create a state in which imidization of the polyimide precursor has not proceeded completely and a part or a large part of the organic solvent has been removed. Further, having self-supporting property refers to a state of having strength to such a degree that the self-supporting film can be peeled from the metal belt 3.

Although there is no particular limitation on the drying condition (heating condition) for forming the self-supporting film 1b, the self-supporting film 1b may be produced by heating at a temperature of 100 to 180° C. for about 2 to 60 minutes in thermal imidization.

In the drying furnace 5, a self-supporting film is formed by heating a polyimide precursor at a temperature at which imidization of the polyimide precursor does not proceed completely and a part or a large part of an organic solvent can be removed, while moving the metal support. Further, a thin film on the upper surface of the support is appropriately dried on the support by drying means such as a heater or a hot air blowing device to remove a large part of a solvent. The drying means such as a heater or a hot air blowing device includes a plurality of blocks (zones) having different temperatures in a width direction and/or a conveying direction of a cast. As a drying medium of the drying means, there are given an infrared heater, hot air (hot gas obtained by heating gas such as air), and the like.

The self-supporting film 1b is not particularly limited, as long as a solvent is removed from the film to such a degree that the film can be peeled from the support, and/or the film is imidized. In the case of thermal imidization, it is preferred that a loss-on-heating be in a range of 20 to 50% by mass. When the loss-on-heating is in the range of 20 to 50% by mass, the mechanical properties of the self-supporting film become sufficient.

Herein, the loss-on-heating of the self-supporting film 1b is a value obtained from a mass W1 of the self-supporting film and a mass W2 of the film after being cured by the following equation.

Loss-on-heating (% by mass) (W1−W2)/W1×100

The self-supporting film 1b is peeled from the metal belt 3. There is no particular limitation on a peeling method, and an example of the method is a method involving cooling a self-supporting film and applying a tension to the film via a roll to peel the film.

(Post-Heating Step)

In the post-heating step, the self-supporting film 1b is introduced into the heating furnace 6 and subjected to heat treatment to remove a solvent and complete imidization, thereby obtaining the polyimide film 1c.

As a heating method for the self-supporting film 1b, a known method may be used. As an example of the heating method, the following is performed appropriately: a polymer is imidized and a solvent is evaporated and removed first at a temperature of about 100° C. to 400° C. for about 0.05 to 5 hours, in particular, 0.1 to 3 hours gradually. In particular, the heating method is preferably performed in a stepwise manner as follows. That is, a primary heat treatment is conducted at a relatively low temperature of about 100° C. to about 170° C. for about 0.5 to 30 minutes, then a secondary heat treatment is conducted at a temperature of 170° C. to 220° C. for about 0.5 to 30 minutes, and then a tertiary heat treatment is conducted at a high temperature of 220° C. to 400° C. for about 0.5 to 30 minutes. If required, a quaternary high-temperature heat treatment may be conducted at a high temperature of 400° C. to 550° C., preferably 450° C. to 520° C.

At a time of heat treatment for completing imidization, in a cure furnace, heat treatment may be conducted under the condition that at least both side edges in a direction perpendicular to a longitudinal direction of a long solidified film, i.e., in a width direction of the film are fixed with a pin tenter, a clip, a frame, or the like, and if required, the film is enlarged or contracted in the width direction or the length direction.

As heating means for post-heating a self-supporting film, there is given a heater or a hot air blowing device. The heating means such as a heater or a hot air blowing device includes a plurality of blocks (zones) having different temperatures in a width direction and/or a conveying direction of a cast. As a heating medium of the heating means, there are given an infrared heater, hot air (hot gas obtained by heating gas such as air), and the like.

Although there is no particular limitation on the thickness of the polyimide film of the present invention, the thickness is about 3 to 250 μm, preferably about 4 to 150 μm, more preferably 5 to 125 μm, still more preferably 5 to 100 μm. According to the present invention, there can be provided a polyimide film having excellent characteristics even when the thickness of the film is as thin as 20 μm or less, further 15 μm or less, still further 10 μm or less. In the case of producing a thin film, a heating time may be short.

The polyimide film 1c after being subjected to the post-heating step may be taken up to a roll shape by the take-up device 7 or the like.

(Measurement of Solvent Content by Infrared Spectroscopy)

A polyimide film is produced through the above-mentioned steps. In the present invention, the solvent content of the self-supporting film 1b is measured with the solvent content measurement means 4 by infrared spectroscopy. The solvent content of the self-supporting film 1b has only to be measured before the post-heating step. Then, based on the measurement result, one or more kinds selected from the drying condition of the cast polyimide precursor, the post-heating condition of the self-supporting film, and the amount of extrusion from the die of the polyimide precursor solution are controlled.

The measurement of a solvent content of a self-supporting film by infrared spectroscopy is conducted by irradiating a self-supporting film to be measured with an infrared ray, converting the intensity of reflected light or transmitted light into absorbance characteristics, and converting the obtained absorbance characteristics into a solvent content of the self-supporting film based on an intensity ratio with a reference wavelength by the Lambert-Beer law.

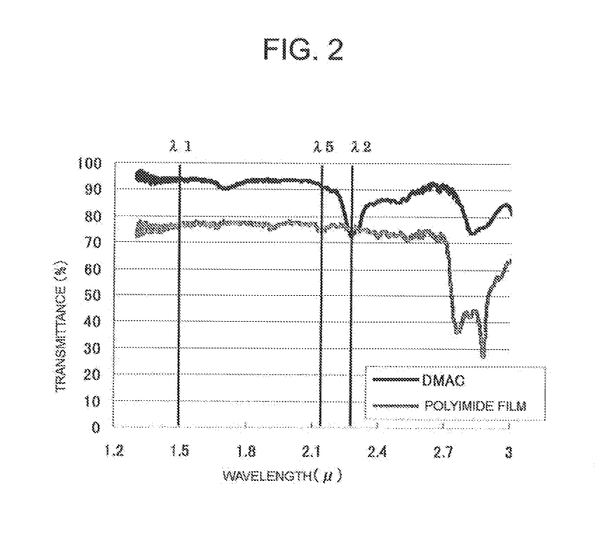

FIG. 2 shows spectral characteristics obtained by irradiating N,N-dimethylacetamide (hereinafter, referred to as “DMAc”) and a polyimide film (UPILEX-Smanufactured by UBE INDUSTRIES, LTD.) with an infrared ray, respectively. The content of DMAc, i.e., the solvent content may be obtained by selecting a wavelength (λ2) having an absorption peak in DMAc and having no absorption peak in the polyimide film, a wavelength (λ5) having no absorption peak in DMAc and having an absorption peak in the polyimide film, and a wavelength (λ1) having no absorption peak in any one of DMAc and the polyimide film, and performing calculation by the following equations (1) to (3) based on intensity ratios between the selected wavelengths. Although the polyimide film is used in this example, it should be noted that, even when a self-supporting film is used instead of the polyimide film, peaks of λ1, λ2, and λ5 are present in the same way as in this example.

Polymer amount=Absorbance at λ5/Absorbance at λ1 (1)

Solvent amount=Absorbance at λ2/Absorbance at λ1 (2)

Solvent content=Solvent amount/(Solvent amount+polymer amount) (3)

The solvent content of a self-supporting film can be measured by infrared spectroscopy, for example, through use of “IM series” (trade name) available from CHINO Corporation.

Although the solvent content can be grasped by the above-mentioned procedure, it is preferred to further create a calibration curve as described below to obtain a solvent content converted by the calibration curve. Thus, the measured solvent content can be further approximated to a value of a solvent content actually measured by another measurement method such as a loss-on-heating method.

Specifically, the same film as the self-supporting film used for measurement by infrared spectroscopy is measured by the loss-on-heating method. Then, the weight of the heated film is defined as a polymer amount, and a difference between an initial weight (weight before heating) of the self-supporting film and the weight of the heated film is defined as a solvent amount. The polymer amount and solvent amount obtained by the equations (1) and (2) are compared and associated with the polymer amount and solvent amount obtained by the loss-on-heating method. Thus, a calibration curve can be created. The polymer amount, solvent amount, and solvent content can also be converted into absolute values by creating the calibration curve.

The drying condition of the polyimide precursor solution, the post-heating condition of the self-supporting film, and the amount of extrusion from the die of the polyimide precursor solution may be controlled through use of any of the results of the solvent content obtained by infrared spectroscopy and the solvent content converted by the calibration curve created as described above. It is preferred to use the solvent content converted by the calibration curve.

It should be noted that, according to infrared spectroscopy, a particular narrow region of the self-supporting film is irradiated with an infrared ray. Thus, the solvent content obtained by infrared spectroscopy is a numerical value at a pinpoint. In contrast, according to the loss-on-heating method, a self-supporting film having a predetermined width and length is used. Thus, the solvent content obtained by the loss-on-heating method is an average value of the film having a predetermined width and length.

The measurement of a solvent content by infrared spectroscopy can be conducted merely by irradiating a self-supporting film with an infrared ray. Therefore, a facility can be in-lined, and the solvent content of a self-supporting film can be measured with good precision. Further, the solvent content can be measured in a short period of time, and hence the measurement result can be fed back substantially in real time to control one or more kinds selected from the amount of extrusion from the die of the polyimide precursor solution, the drying condition of the cast polyimide precursor, and the post-heating condition of the self-supporting film.

(Control Method in Control Device)

Hereinafter, a control method in the control device 8 is described.

(First Aspect (Control of Drying Condition))

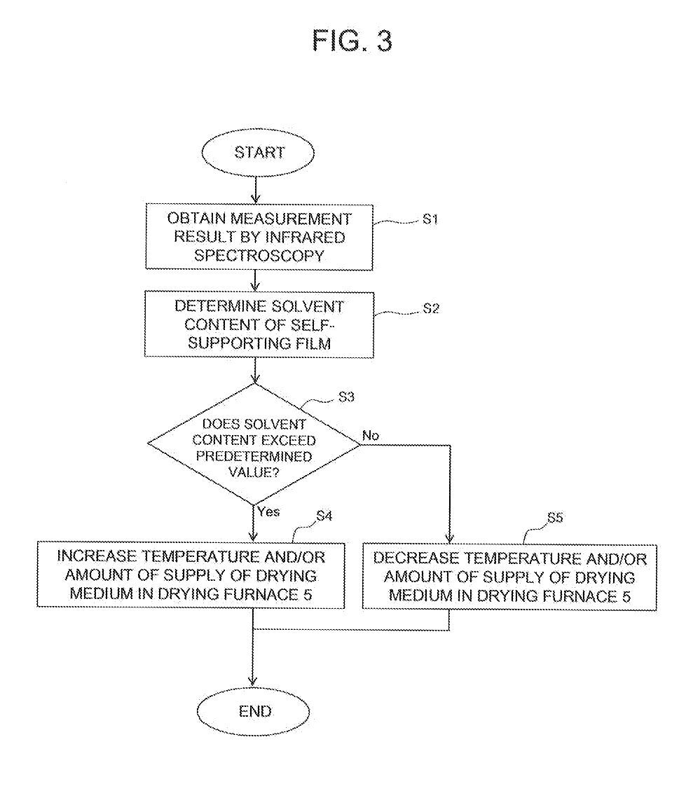

As a first aspect, the case of controlling the drying condition of the cast polyimide precursor based on the measurement result of the solvent content of the self-supporting film is described with reference to a flowchart illustrated in FIG. 3. In this case, the drying condition of the cast polyimide precursor 1a is controlled so that the solvent content in the width direction of the self-supporting film 1b becomes substantially uniform.

As illustrated in FIG. 3, first, a measurement result by infrared spectroscopy is obtained (Step S1), and a solvent content of a self-supporting film is determined based on the measurement result (Step S2). As described above, the measurement of the solvent content of the self-supporting film by infrared spectroscopy can be conducted by irradiating the self-supporting film to be measured with an infrared ray, converting the intensity of reflected light or transmitted light into absorbance characteristics, and converting the obtained absorbance characteristics into a solvent content of the self-supporting film based on the intensity ratio with a reference wavelength by the Lambert-Beer law.

The solvent content measured by infrared spectroscopy is compared with a previously determined solvent content of a predetermined value (Step S3). Specifically, a difference between the measured value of the solvent content and the predetermined value is checked. Then, in the case where the solvent content exceeds the predetermined value, the temperature and/or amount of supply of a drying medium for drying a cast portion corresponding to the portion of the self-supporting film measured for the solvent content in the drying furnace 5 are increased (Step S4). In the case where the solvent content is less than the predetermined value, the temperature and/or amount of supply of the drying medium for drying a cast portion corresponding to the portion of the self-supporting film measured for the solvent content in the drying furnace 5 are decreased (Step S5). When the solvent content is the predetermined value, the control of drying medium is not conducted. As the predetermined value, a value with a certain range may be set (the same applies to the following aspect).

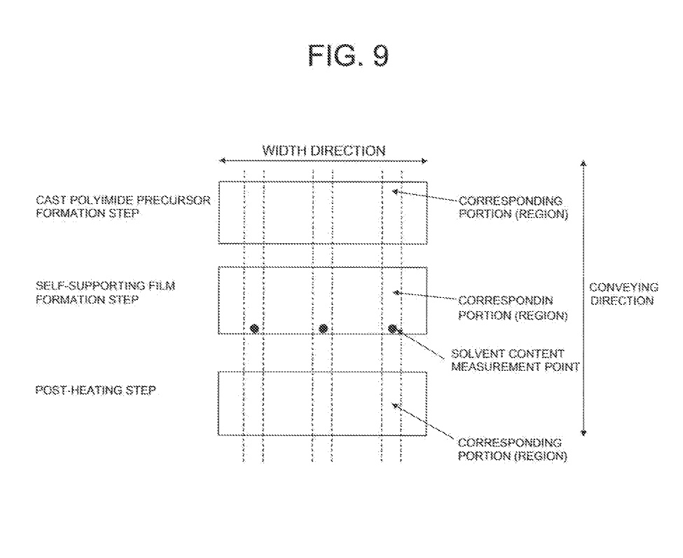

Herein, as illustrated in FIG. 9, the cast portion corresponding to the portion of the self-supporting film measured for the solvent content refers to a partial region of a cast in the self-supporting film formation step corresponding to the measurement point of the self-supporting film measured for the solvent content, when viewed in the width direction. In FIG. 9, the cast portion is indicated by a rectangular region defined by vertical dotted lines and horizontal solid lines in the self-supporting film formation step. As illustrated in FIG. 9, the region of the cast portion may have a predetermined width in the width direction, when viewed from the measurement point of the self-supporting film measured for the solvent content.

Specifically, the temperature and/or amount of supply of the drying medium for drying the cast portion are increased or decreased. Examples of the drying medium include an infrared heater and hot air (hot gas obtained by heating gas such as air). As means for increasing or decreasing the amount of supply of the drying medium, there are given a freely openable and closable damper and the like. Regarding a portion (region) having a high solvent content in the width direction of the self-supporting film 1b, the temperature or amount of supply of the drying medium is increased and regarding a portion having a low solvent content thereof, the temperature or amount of supply of the drying medium is decreased so that the solvent content in the width direction becomes uniform. By rendering the solvent content substantially uniform in the width direction of the self-supporting film 1b, the contraction degree of the self-supporting film 1b in the post-heating step can be rendered uniform. Thus, troubles such as variations in physical properties of a polyimide film and a dimensional error thereof due to a stress locally applied to the self-supporting film 1b are solved.

(Second Aspect (Control of Post-Heating Condition))

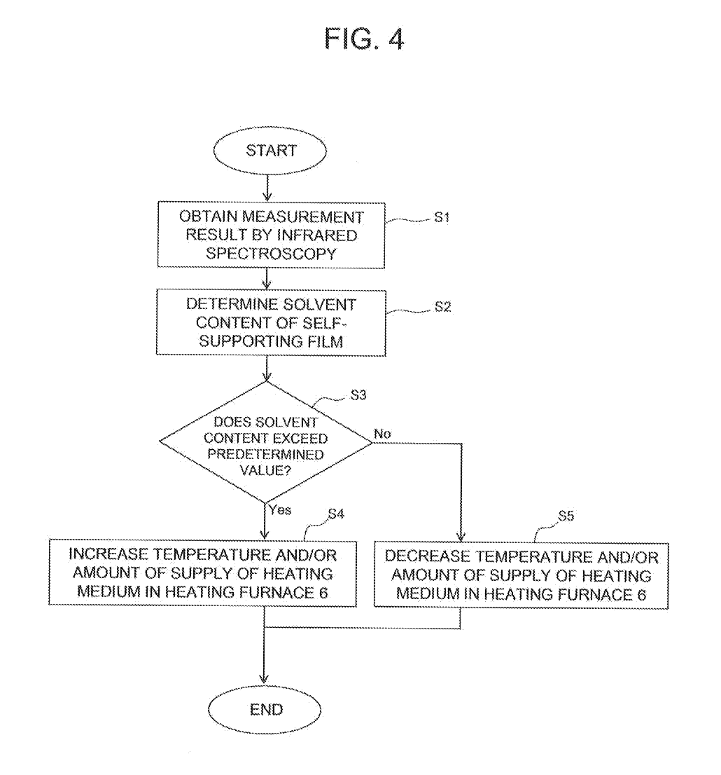

Next, as a second aspect of the control method in the control device 8, the case of controlling the heating condition of the self-supporting film in the post-heating step based on the measurement result of the solvent content of the self-supporting film is described with reference to a flow chart illustrated in FIG. 4. In this case, the variation in characteristics in the width direction of polyimide to be obtained is reduced by changing the heating condition in accordance with the solvent content in the width direction of the self-supporting film.

As illustrated in FIG. 4, first, a measurement result by infrared spectroscopy is obtained in the same manner as described above (Step S1), and a solvent content of a self-supporting film is determined based on the measurement result (Step S2). Then, the solvent content measured by infrared spectroscopy is compared with the previously determined solvent content of the predetermined value (Step S3). In the case where the solvent content exceeds the predetermined value, the temperature and/or amount of supply of a heating medium for heating a film in a portion of the heating furnace 6 corresponding to the portion of the self-supporting film measured for the solvent content are increased (Step S4). In the case where the solvent content is less than the predetermined value, the temperature and/or amount of supply of the heating medium for heating a film in a portion of the heating furnace 6 corresponding to the portion of the self-supporting film measured for the solvent content are decreased (Step S5). When the solvent content is the predetermined value, the control of heating medium is not conducted.

Herein, as illustrated in FIG. 9, the film in the portion of the heating furnace 6 corresponding to the portion of the self-supporting film measured for the solvent content refers to a partial region of a film in the post-heating step corresponding to the measurement point of the self-supporting film measured for the solvent content, when viewed in the width direction. In FIG. 9, the film portion is indicated by a rectangular region defined by vertical dotted lines and horizontal solid lines in the post-heating step. As illustrated in FIG. 9, the region of the film portion may have a predetermined width in the width direction, when viewed from the measurement point of the self-supporting film measured for the solvent content.

Specifically, the temperature and/or amount of supply of the heating medium for post-heating the film are increased or decreased. Examples of the heating medium include an infrared heater and hot air (hot gas obtained by heating gas such as air). As means for increasing or decreasing the amount of supply of the heating medium, there are given a freely openable and closable damper and the like. Regarding a portion having a high solvent content in the width direction of the self-supporting film 1b, the temperature or amount of supply of the heating medium at the initial stage of post-heating is increased and regarding a portion having a low solvent content thereof, the temperature or amount of supply of the heating medium at the initial stage of post-heating is decreased so that the solvent content in the middle of post-heating becomes uniform. As a result, the contraction degree of the self-supporting film can be rendered substantially uniform. Thus, troubles such as variations in physical properties of a polyimide film and a dimensional error thereof due to a stress locally applied to the self-supporting film are solved.

(Third Aspect (Control of Amount of Extrusion))

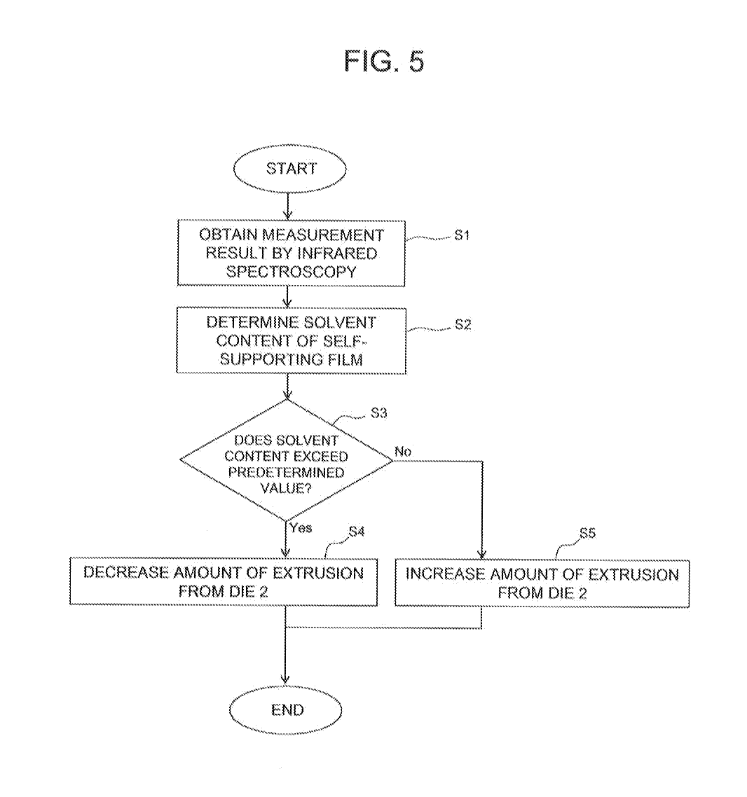

Next, as a third aspect of the control method in the control device 8, the case of controlling the amount of extrusion from the die of the polyimide precursor solution based on the measurement result of the solvent content of the self-supporting film is described with reference to a flow chart illustrated in FIG. 5. In this case, the amount of extrusion from the die of the polyimide precursor solution 1 is controlled so that the solvent content in the width direction of the self-supporting film 1b becomes substantially uniform.

As illustrated in FIG. 5, first, a measurement result by infrared spectroscopy is obtained in the same manner as described above (Step S1), and a solvent content of a self-supporting film is determined based on the measurement result (Step S2). Then, the solvent content measured by infrared spectroscopy is compared with the previously determined solvent content of the predetermined value (Step S3). In the case where the solvent content exceeds the predetermined value, the amount of extrusion from the die 2 for a cast portion corresponding to the portion of the self-supporting film measured for the solvent content is decreased (Step S4). In the case where the solvent content is less than the predetermined value, the amount of extrusion from the die 2 for a cast portion corresponding to the portion of the self-supporting film measured for the solvent content is increased (Step S5). When the solvent content is the predetermined value, the control of amount of extrusion from the die 2 is not conducted.

Herein, as illustrated in FIG. 9, the die for the cast portion corresponding to the portion of the self-supporting film measured for the solvent content refers to a die portion corresponding to the measurement point of the self-supporting film measured for the solvent content, when viewed in the width direction. In FIG. 9, the die portion is indicated by a die portion for supplying the polyimide precursor solution to a rectangular region of the cast portion defined by vertical dotted lines and horizontal solid lines in the cast polyimide precursor formation step. As illustrated in FIG. 9, the region of the cast portion may have a predetermined width in the width direction, when viewed from the measurement point of the self-supporting film measured for the solvent content.

Based on the obtained measurement value, regarding a portion having a high solvent content in the width direction of the self-supporting film 1b, the amount of extrusion from the die of the polyimide precursor solution 1 is decreased, and regarding a portion having a low solvent content thereof, the amount of extrusion from the die of the polyimide precursor solution 1 is increased.

As a method of decreasing or increasing the amount of extrusion from the die, the following methods (a) and (b) are preferably given. Further, the methods (a) and (b) may be combined.

(a) A method involving adjusting an interval in a height direction of a path of a die with a screw, a spring, a heat bolt, or the like.

(b) A method involving adjusting the temperature of a polyimide precursor solution discharged from a tip end of a die.

The amount of extrusion of a polyimide precursor solution in the width direction to be extruded from a path of a tip end of a die is changed by changing an interval in a height direction of the path of the tip end of the die or changing the temperature of the polyimide precursor solution to be extruded from the tip end of the die. Therefore, regarding a thin portion of the cast polyimide precursor, the interval in the height direction of the path of the tip end of the die is enlarged, or the temperature of the polyimide precursor solution to be extruded from the tip end of the die is raised, in the corresponding portion and in the vicinity thereof, thereby increasing the amount of extrusion of the polyimide precursor solution. Regarding a thick portion of the cast polyimide precursor, the interval in the height direction of the path of the tip end of the die is narrowed, or the temperature of the polyimide precursor solution to be extruded from the tip end of the die is lowered, in the corresponding portion and in the vicinity thereof, thereby decreasing the amount of extrusion of the polyimide precursor solution. Thus, the thickness distribution in the width direction of the cast polyimide precursor can be rendered uniform.

It should be noted that, in the present invention, it is preferred that the measurement by infrared spectroscopy be conducted at a plurality of points in the width direction of the self-supporting film 1b. With this, one or more kinds selected from the drying condition of the cast polyimide precursor, the post-heating condition of the self-supporting film, and the amount of extrusion from the die of the polyimide precursor solution can be controlled more precisely, based on the solvent content in the width direction of the self-supporting film.

Further, in the present invention, the solvent content may be measured by measurement means capable of measuring the solvent content at a plurality of points in the width direction of the self-supporting film 1b by allowing a measurement mechanism using infrared spectroscopy to scan the film. Specifically, there is given an embodiment including rails for allowing the measurement mechanism to scan the self-supporting film 1b substantially in parallel to the width direction. With this, the measurement by infrared spectroscopy can be conducted more efficiently and more rapidly. Further, the solvent content may be measured by measurement means which is provided with two or more measurement mechanisms each using infrared spectroscopy in the width direction of the self-supporting film 1b and is capable of measuring the solvent content at a plurality of points in the width direction.

Next, another embodiment of the method for the production of a polyimide film according to the present invention is described similarly with reference to FIG. 1.

In this embodiment, the thickness of the cast polyimide precursor 1a before being dried is measured by thickness measurement means 9, and the measurement result is fed back to the control device 8 to control the extrusion of the polyimide precursor solution 1 from the die 2 so that the thickness of the cast polyimide precursor 1a in the width direction becomes uniform. It should be noted that this embodiment may be carried out independently from the method for the production of a polyimide film, which uses the control method shown in any of the first to third aspects. Alternatively, this embodiment can also be carried out in combination with such control method.

The cast polyimide precursor 1a is formed on the metal belt 3, and the surface shape of the metal belt 3 is transferred to the cast polyimide precursor 1a. Therefore, the metal belt 3 is mirror-finished in most cases. For this reason, in the film thickness measurement of the cast polyimide precursor 1a, it is preferred to use measurement means which is not influenced by specular reflection from the metal belt 3 subjected to mirror-finishing and is capable of measuring the film thickness with good precision even at a distance from the metal belt 3. Specifically, measurement means utilizing (1) a confocal method using laser light, (2) a spectral interference method using a superluminescent diode (SLD), or the like is preferably used.

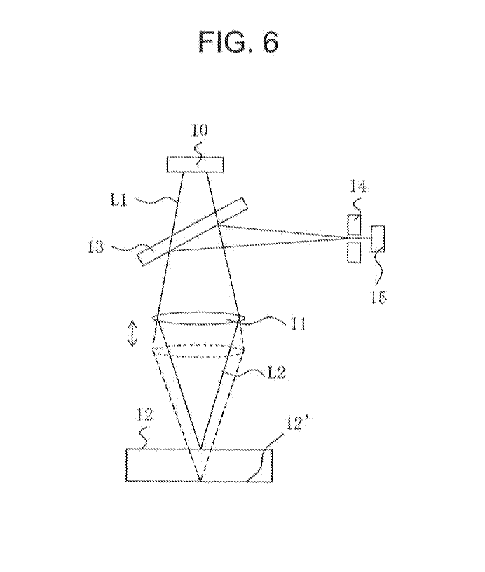

According to the measurement principle of the confocal method using laser light, as illustrated in FIG. 6, laser light L1 emitted from a light source 10 passes through an objective lens 11, which moves up and down at a high speed, and is focused on an object surface 12, and reflected light L2 reflected from the object surface 12 passes through a half mirror 13 and a pinhole 14 and reaches a light-receiving element 15. When the laser light L1 is focused on the object surface 12, the reflected light L2 is condensed at one point at a position of the pinhole and is entered into the light-receiving element. The position of the objective lens 11 at that time is measured with a sensor. Thus, a distance between the objective lens 11 and the object surface 12 can be measured. Similarly, a distance between the objective lens 11 and an object back surface 12′ can also be measured by ascending or descending the objective lens 11, and hence the thickness of the object can be measured.

Thus, according to the confocal method using laser light, a distance is measured at the position of a focus, and hence a thickness can be measured without being influenced by a change in surface reflectance of an object to be measured.

Examples of the measurement means utilizing the confocal method using laser light include “LT-9000 series” (trade name) available from Keyence Corporation.

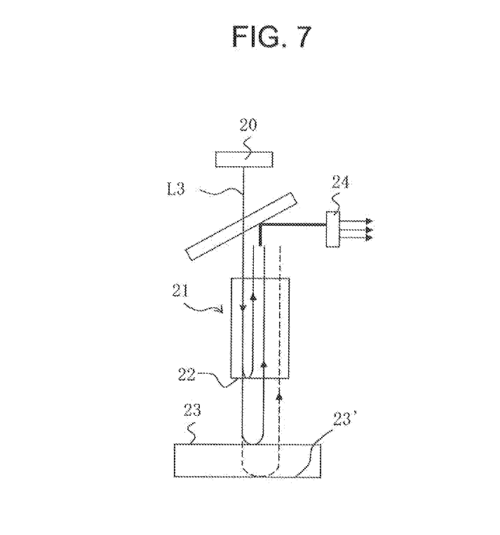

Further, according to the measurement principle using the spectral interference method using an SLD, as illustrated in FIG. 7, light L3 in a wide wavelength range emitted from an SLD (light source) 20 is reflected from two surfaces of a sensor head 22 inside an optical fiber 21 and an object surface 23 and returns to the optical fiber 21. Two reflected light beams interfere with each other, and the intensity of interference light at each wavelength depends on the distance between the sensor head 22 and the object surface 23. Therefore, the distance between the sensor head 22 and the object surface 23 can be measured by analyzing the interference light at each wavelength separated by a spectroscope 24. Similarly, the distance between the sensor head 22 and an object back surface 23′ can also be measured, and hence the thickness of the object can be measured.

In the case where white light or the like is used as a light source, the reflected light from the back surface 23′ is more intense than the reflected light from the object surface 23, which makes it difficult to conduct measurement. The reflected light from the object surface 23 is obtained sufficiently by using an SLD as a light source, and hence the measurement is not easily influenced by the reflected light from the back surface 23′.

Examples of the measurement device utilizing the spectral interference method using an SLD include “S1-F01” (trade name) available from Keyence Corporation.

(Fourth Aspect (Control of Amount of Extrusion))

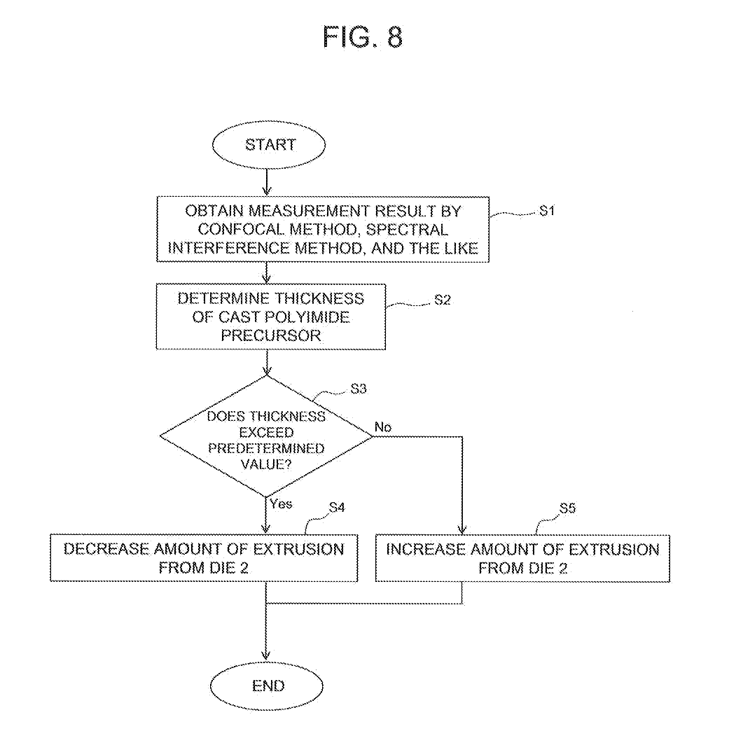

Hereinafter, as a fourth embodiment of the control method in the control device 8, the case of controlling an amount of extrusion of a polyimide precursor solution from a die based on the measurement result of the thickness of a cast of the polyimide precursor solution before being dried is described with reference to a flow chart illustrated in FIG. 8. It should be noted that this control can be performed independently from or together with the above-mentioned control illustrated in each of FIGS. 3 to 5.

As illustrated in FIG. 8, first, a measurement result by the confocal method using laser light, the spectral interference method using a superluminescent diode (SLD), or the like is obtained (Step S1). The thickness of a cast polyimide precursor is determined based on the measurement result (Step S2). As described above, according to the confocal method using laser light, laser light emitted from a light source passes through an objective lens that moves up and down at a high speed and is focused on an object surface, and similarly, laser light is focused on an object back surface by ascending or descending an objective lens. Therefore, the thickness of the object can be determined through conversion from a displacement of the position of a focus. Further, according to the spectral interference method using a superluminescent diode (SLD), light in a wide wavelength range emitted from the SLD (light source) is reflected from two surfaces of a sensor head inside an optical fiber and an object surface, and similarly, light is reflected from two surfaces of the sensor head inside the optical fiber and the object back surface. The reflected light beams interfere with each other, and the intensity at each wavelength of the interference light depends on a reflected position. Therefore, the thickness of the object can be determined by analyzing the interference light at each wavelength separated by a spectroscope.

Then, the above-mentioned thickness is compared with a previously determined thickness of a predetermined value (Step S3). In the case where the thickness exceeds the predetermined value, the amount of extrusion from the die 2 is decreased (Step S4), and in the case where the thickness is less than the predetermined value, the amount of extrusion from the die 2 is increased (Step S5). In the case where the thickness is the predetermined value, the amount of extrusion from the die 2 is not increased or decreased. In this case, as the predetermined value, a value with a certain range may be set.

As a preferred example of the control of extrusion of the polyimide precursor solution 1 from the die 2, there is given a method in which the amount of extrusion of a polyimide precursor solution extruded from a tip end of a die is adjusted by a plurality of extrusion amount adjustment mechanisms based on the thickness measurement value in the width direction of the cast polyimide precursor 1a through use of the die having a plurality of extrusion amount adjustment mechanisms capable of adjusting the amount of extrusion in the width direction of the polyimide precursor solution extruded from the tip end of the die, and the distribution of the cast polyimide precursor is made uniform in the width direction.

Preferred examples of the method of decreasing or increasing the amount of extrusion from the die include the above-mentioned methods (a) and (b). Further, the methods (a) and (b) may be combined.

According to this aspect, the thickness of the cast polyimide precursor 1a in a state before being introduced into the drying furnace 5 is measured, and the extrusion of the polyimide precursor solution 1 from the die 2 is controlled so that the thickness of the cast polyimide precursor 1a in the width direction becomes uniform, whereby the feedback result can be reflected in an early stage. Therefore, the amount of a product to be wasted can be reduced, and a polyimide film having less thickness unevenness can be produced with high productivity.

It should be noted that, in the present invention, it is preferred that the above-mentioned thickness measurement be conducted at a plurality of points in the width direction of the cast polyimide precursor 1a. Thus, the amount of extrusion of a polyimide precursor solution from a die can be controlled more precisely based on the thickness in the width direction of the cast polyimide precursor before being heated.

Further, in the present invention, the above-mentioned thickness measurement may be conducted with measurement means capable of measuring the thickness at a plurality of points in the width direction of the cast polyimide precursor 1a by allowing a measurement mechanism by the confocal method using laser light, the spectral interference method using a superluminescent diode, or the like, to scan the cast polyimide precursor 1a. Thus, the above-mentioned thickness measurement can be conducted more efficiently at a high speed.

Further, the above-mentioned control of FIG. 8 may be performed together with the control illustrated in FIG. 3, 4, or 5, whereby the above-mentioned measurement of a solvent content of a self-supporting film and the above-mentioned measurement of a thickness of a cast polyimide precursor are conducted in combination, and one or more kinds selected from the drying condition of a cast polyimide precursor, the post-heating condition of a self-supporting film, and the amount of extrusion of a polyimide precursor solution from a die may be controlled based on the feedback of each measurement result.

In the embodiment as described above, the polyimide precursor solution 1 is cast onto the metal belt 3 to form the cast polyimide precursor 1a, the cast polyimide precursor 1a is heated to form the self-supporting film 1b and peeled from the metal belt 3, and the self-supporting film 1b is heated again to remove a solvent and complete imidization, whereby the polyimide film 1c is produced. Alternatively, the polyimide precursor solution 1 is cast onto a metal foil such as a copper foil to obtain a metal foil with a cast polyimide precursor formed on its surface, the resultant is heated to form the cast polyimide precursor into a self-supporting film, and the self-supporting film is heated again in a state in which the self-supporting film is integrated with the metal foil to remove a solvent and complete imidization. Thus, a complex film in which a polyimide film is laminated on the metal foil can be produced. In this aspect, the metal foil corresponds to a metal support in the present invention.

Further, although the metal belt is used as the metal support, a metal drum or the like may also be suitably used instead of the metal belt.

According to the present invention, a polyimide film whose thickness is homogeneous in the width direction and in the length direction can be obtained. The polyimide film obtained in the present invention may be used as a material for electronic components and electronic equipment: such as a cover base material for a printed wiring board, a flexible printed board, a TAB tape, a COF tape, a chip member such as an IC chip, and the like; and a base material or a cover material for a liquid crystal display, an organic electroluminescence display, electronic paper, a solar battery, and the like.

### EXAMPLES

### Test Example 1

### Measurement of Solvent Content by Infrared Spectroscopy (IR)

A self-supporting film whose thickness after post-heating was equivalent to 25 μm was irradiated with infrared rays in a direction perpendicular to the conveying direction of the film (width direction). As an infrared spectroscopic device, IM (manufactured by CHINO Corporation) was used. An apparatus including a measurement device having a measurement area of 50 mm in the witch direction and 50 mm in the flow direction and a mechanism that allows the measurement device to reciprocate was operated, and the fixed self-supporting film was continuously measured in the width direction. As the measurement result, an average value for each travel of 50 mm in the width direction was set to be an output.

Based on the measurement result, a wavelength (λ2) having an absorption peak in the solvent and having no absorption peak in the polyimide film, a wavelength (λ5) having no absorption peak in the solvent and having an absorption peak in the polyimide film, and a wavelength (λ1) having no absorption peak in any one of the solvent and the polyimide film were selected. The solvent content was determined with the following equations (1) to (3) from ratios of absorbances obtained in the case of irradiating the self-supporting film to be measured with infrared rays having the wavelengths.

Polymer amount=Absorbance at λ5/Absorbance at λ1 (1)

Solvent amount=Absorbance at λ2/Absorbance at λ1 (2)

Solvent content=Solvent amount/(Solvent amount+polymer amount) (3)

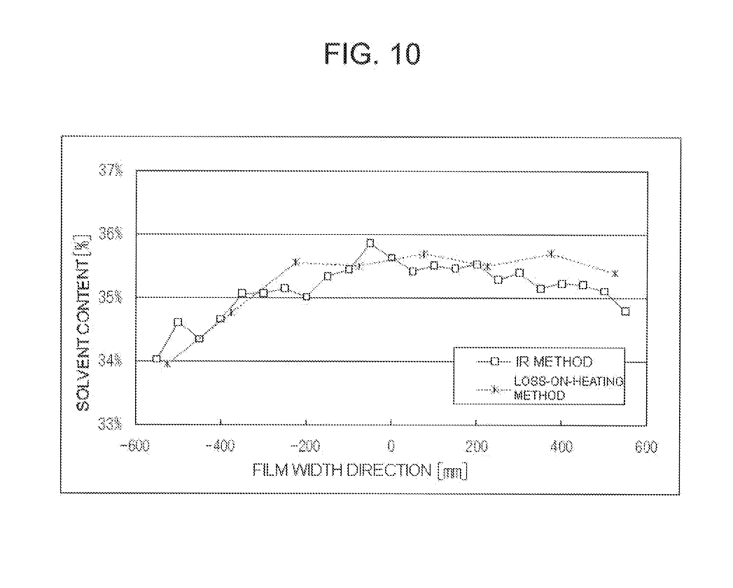

The results are shown in Table 1 and FIG. 10. In this case, the measurement position in Table 1 indicates the distance from the center in the width direction of the self-supporting film. A minus “−” indicates the left side of the self-supporting film and a plus “+” indicates the right side thereof. Further, the solvent content shown in Table 1 is a numerical value, which is converted through a calibration curve created with comparison of the polymer amount and solvent amount determined with the equations (1) and (2) with the polymer amount and solvent amount determined by a loss-on-heating Method to create.

TABLE 1

| Measurement | | | | Solvent |
|---|---|---|---|---|
| position | Peak intensity | | | content |
| (mm) | λ1 | λ2 | λ5 | (% by mass) |
| −550 | 1.175 | 0.831 | 0.974 | 34.0 |
| −500 | 1.127 | 0.810 | 0.941 | 34.6 |
| −450 | 1.129 | 0.802 | 0.939 | 34.3 |
| −400 | 1.124 | 0.795 | 0.933 | 34.7 |
| −350 | 1.119 | 0.787 | 0.926 | 35.1 |
| −300 | 1.116 | 0.787 | 0.925 | 35.1 |
| −250 | 1.102 | 0.779 | 0.915 | 35.1 |
| −200 | 1.089 | 0.764 | 0.901 | 35.0 |
| −150 | 1.081 | 0.754 | 0.892 | 35.3 |
| −100 | 1.082 | 0.753 | 0.893 | 35.4 |
| −50 | 1.076 | 0.750 | 0.889 | 35.9 |
| 0 | 1.074 | 0.746 | 0.885 | 35.6 |
| 50 | 1.070 | 0.746 | 0.883 | 35.4 |
| 100 | 1.067 | 0.743 | 0.880 | 35.5 |
| 150 | 1.058 | 0.735 | 0.872 | 35.5 |
| 200 | 1.083 | 0.756 | 0.894 | 35.5 |
| 250 | 1.050 | 0.728 | 0.864 | 35.3 |
| 300 | 1.047 | 0.727 | 0.861 | 35.4 |
| 350 | 1.040 | 0.722 | 0.856 | 35.1 |
| 400 | 1.039 | 0.721 | 0.855 | 35.2 |
| 450 | 1.035 | 0.720 | 0.853 | 35.2 |
| 500 | 1.033 | 0.721 | 0.851 | 35.1 |
| 550 | 1.028 | 0.716 | 0.846 | 34.8 |

### Test Example 2

### Measurement of Solvent Content by Loss-on-Heating Method

A solvent content was measured by a loss-on-heating method so as to be compared with the measurement result of the solvent content by infrared spectroscopy. A self-supporting film was cut into a size of 50 mm in the width direction and 100 mm in the flow direction at an equal interval in the width direction, and the change in weight between the initial weight (before drying) and the weight after heating (after drying) was measured. The heating condition was as follows: the film was heated to a temperature of 400° C. at a rate of temperature increase of 5° C./min in an electric furnace at 300° C. and held at the temperature for 30 minutes.

The solvent content was determined with the following equation.

Solvent content=[(Initial weight of self-supporting film−Weight after heating)/Initial weight of self-supporting film]×100

The results are shown in Table 2 and FIG. 10. In this case, the measurement position in Table 2 indicates the distance from the center in the width direction of the self-supporting film. A minus “−” indicates the left side of the self-supporting film and a plus “+” indicates the right side thereof.

TABLE 2

| | | |
|---|---|---|
| Measurement | Weight of film | Solvent |

| position | Before drying | After drying | content |
|---|---|---|---|
| (mm) | (g) | (g) | (% by mass) |
| −525 | 0.264 | 0.174 | 34.0 |
| −375 | 0.285 | 0.186 | 34.8 |
| −225 | 0.275 | 0.177 | 35.6 |
| −75 | 0.281 | 0.181 | 35.5 |
| 75 | 0.282 | 0.182 | 35.7 |
| 225 | 0.281 | 0.181 | 35.5 |
| 375 | 0.284 | 0.183 | 35.7 |
| 525 | 0.278 | 0.179 | 35.4 |

It was confirmed from the above-mentioned measurement results of Test Examples 1 and 2 that the distribution of the solvent content in the width direction by infrared spectroscopy was similar to that by a loss-on-heating method, and even when an infrared measurement device was reciprocated, the solvent content was able to be measured with sufficient precision.

### Example 1

### Production of Polyimide Film Through Use of Infrared Spectroscopic Device (Control of Drying Condition)

A polyimide film was produced through use of the infrared spectroscopic device in a drying step. Specifically, regarding a portion having a higher solvent content in a width direction of a self-supporting film than a predetermined solvent content, the amount of supply of dry hot gas for drying a cast portion corresponding to the portion having the higher solvent content in the step of drying the cast of the polyimide precursor solution was increased. Further, regarding a portion having a lower solvent content in a width direction of a self-supporting film than a predetermined solvent content, the amount of supply of dry hot gas for drying a cast portion corresponding to the portion having the lower solvent content in the step of drying the polyimide precursor solution was decreased. With this, the solvent content in the width direction of the self-supporting film became substantially uniform, whereby a polyimide film having physical properties with in-plane uniformity was able to be produced with high productivity while the generation of defective products was prevented.

### Example 2

### Production of Polyimide Film Through Use of Infrared Spectroscopic Device (Control of Post-Heating Condition)

A polyimide film was produced through use of the infrared spectroscopic device in a drying step. Specifically, regarding a portion having a higher solvent content in a width direction of a self-supporting film than a predetermined solvent content, the amount of supply of hot gas for heating the portion having the higher solvent content in the post-heating step was increased. Further, regarding a portion having a lower solvent content in a width direction of a self-supporting film than a predetermined solvent content, the amount of supply of hot gas for heating the portion having the lower solvent content in the post-heating step was decreased. With this, the solvent content in the width direction of the self-supporting film became substantially uniform, whereby a polyimide film having physical properties with in-plane uniformity was able to be produced with high productivity while the generation of defective products was prevented.

### Example 3

### Production of Polyimide Film Through Use of Infrared Spectroscopic Device (Control of Amount of Extrusion from Die)

A polyimide film was produced through use of the infrared spectral device in a drying step. A tip end of a die for casting a polyimide precursor solution has a plurality of extrusion amount adjustment mechanisms in the width direction. Regarding a portion having a higher solvent content in a width direction of a self-supporting film than a predetermined solvent content, the amount of extrusion from a die portion corresponding to the portion having the higher solvent content in the step of extruding the polyimide precursor solution from the tip end of the die was decreased. Further, regarding a portion having a lower solvent content in a width direction of a self-supporting film than a predetermined solvent content, the amount of extrusion from a die portion corresponding to the portion having the lower solvent content in the step of extruding the polyimide precursor solution from the tip end of the die was increased. With this, the solvent content in the width direction of the self-supporting film became substantially uniform, whereby a polyimide film having physical properties with in-plane uniformity was able to be produced with high productivity while the generation of defective products was prevented.

### REFERENCE SIGNS LIST

1: polyimide precursor solution
1a: cast polyimide precursor
1b: self-supporting film
1c: polyimide film
2: die
3: metal belt
4: solvent content measurement means
5: drying furnace
6: heating furnace
7: take-up device
8: control device
9: thickness measurement means

1. A method for the production of a polyimide film, the method comprising:
extruding a polyimide precursor solution containing a polyimide precursor and a solvent from a tip end of a die;
casting the polyimide precursor solution onto a surface of a metal support to form a cast of the polyimide precursor solution;
drying the cast of the polyimide precursor solution to form a self-supporting film having self-supporting property; and
post-heating the self-supporting film,
wherein a solvent content of the self-supporting film before the post-heating is measured by infrared spectroscopy, and based on the measurement result, one or more kinds selected from a drying condition of the cast of the polyimide precursor solution, a post-heating condition of the self-supporting film, and an amount of extrusion of the polyimide precursor solution from the die are controlled.

2. A method for the production of a polyimide film according to claim 1, wherein, based on the measurement result, regarding a portion having a higher solvent content in a width direction of the self-supporting film than a predetermined solvent content, a temperature and/or an amount of supply of a drying medium for drying a cast portion corresponding to the portion having the higher solvent content in the step of drying the cast of the polyimide precursor solution are/is increased, and
regarding a portion having a lower solvent content in a width direction of the self-supporting film than a predetermined solvent content, a temperature and/or an amount of supply of a drying medium for drying a cast portion corresponding to the portion having the lower solvent content in the step of drying the cast of the polyimide precursor solution are/is decreased.

3. A method for the production of a polyimide film according to claim 1, wherein, based on the measurement result, regarding a portion having a higher solvent content in a width direction of the self-supporting film than a predetermined solvent content, a temperature and/or an amount of supply of a heating medium for heating the portion having the higher solvent content in the post-heating step are/is increased, and
regarding a portion having a lower solvent content in a width direction of a self-supporting film than a predetermined solvent content, a temperature and/or an amount of supply of a heating medium for heating the portion having the lower solvent content in the post-heating step are/is decreased.

4. A method for the production of a polyimide film according to claim 1, wherein the tip end of the die includes a plurality of extrusion amount adjustment mechanisms in a width direction,
based on the measurement result, regarding a portion having a higher solvent content in a width direction of the self-supporting film than a predetermined solvent content, an amount of extrusion from a die portion corresponding to the portion having the higher solvent content in the step of extruding the polyimide precursor solution from the tip end of the die is decreased, and
regarding a portion having a lower solvent content in a width direction of the self-supporting film than a predetermined solvent content, an amount of extrusion from a die portion corresponding to the portion having the lower solvent content in the step of extruding the polyimide precursor solution from the tip end of the die is increased.

5. A method for the production of a polyimide film according to claim 1, wherein the solvent content of the self-supporting film is measured with measurement means capable of measuring the solvent content at a plurality of points in the width direction of the self-supporting film by allowing a measurement mechanism by infrared spectroscopy to scan the self-supporting film.

6. A method for the production of a polyimide film according to claim 1, wherein the solvent content of the self-supporting film is determined with the following equations (1) to (3) from ratios of absorbances obtained, in a case of selecting a wavelength (λ2) having an absorption peak in the solvent and having no absorption peak in the polyimide film, a wavelength (λ5) having no absorption peak in the solvent and having an absorption peak in the polyimide film, and a wavelength (λ1) having no absorption peak in any one of the solvent and the polyimide film, and irradiating the self-supporting film to be measured with infrared rays having the wavelengths.
Polymer amount=Absorbance at λ5/Absorbance at λ1 (1)
Solvent amount=Absorbance at λ2/Absorbance at λ1 (2)
Solvent content=Solvent amount/(Solvent amount+polymer amount) (3)

7. A method for the production of a polyimide film according to claim 1, the method further comprising measuring a thickness of the cast of the polyimide precursor solution before the drying, and controlling, based on the measurement result, an amount of extrusion of the polyimide precursor solution from the die so that a thickness in a width direction of the cast becomes substantially uniform.

8. A method for the production of a polyimide film according to claim 7, wherein the measuring of the thickness of the cast of the polyimide precursor solution is carried out by a confocal method using laser light or a spectral interference method using a superluminescent diode.

9. An apparatus for the production of a polyimide film, the apparatus comprising:
an extrusion device for extruding a polyimide precursor solution from a tip end of a die, and casting the polyimide precursor solution onto a surface of a metal support to form a cast of the polyimide precursor solution;
a drying device for drying the cast of the polyimide precursor solution to form a self-supporting film having self-supporting property; and
a heating device for post-heating the self-supporting film,
wherein the apparatus includes: a solvent content measurement means for measuring a solvent content of the self-supporting film by infrared spectroscopy; and a control device for controlling, based on the measurement result, one or more kinds selected from a drying condition of the drying device, a heating condition of the heating device, and an extrusion condition of the extrusion device.

10. An apparatus for the production of a polyimide film according to claim 9, wherein the control device controls, regarding a portion having a higher solvent content in a width direction of the self-supporting film than a predetermined solvent content, a temperature and/or an amount of supply of a drying medium for drying a cast portion corresponding to the portion having the higher solvent content in the drying device so as to increase the temperature and/or the amount of supply, and
the control device controls, regarding a portion having a lower solvent content in a width direction of the self-supporting film than a predetermined solvent content, a temperature and/or an amount of supply of a drying medium for drying a cast portion corresponding to the portion having the lower solvent content in the drying device so as to decrease the temperature and/or the amount of supply.

11. An apparatus for the production of a polyimide film according to claim 9, wherein the control device controls, regarding a portion having a higher solvent content in a width direction of the self-supporting film than a predetermined solvent content, a temperature and/or an amount of supply of a heating medium for heating the portion having the higher solvent content in the heating device so as to increase the temperature and/or the amount of supply, and
the control device controls, regarding a portion having a lower solvent content in a width direction of the self-supporting film than a predetermined solvent content, a temperature and/or an amount of supply of a heating medium for heating the portion having the lower solvent content in the heating device so as to decrease the temperature and/or the amount of supply.

12. An apparatus for the production of a polyimide film according to claim 9, wherein the control device controls, regarding a portion having a higher solvent content in a width direction of the self-supporting film than a predetermined solvent content, an amount of extrusion of the polyimide precursor solution from a die portion corresponding to the portion having the higher solvent content in the extrusion device so as to decrease the amount of extrusion, and
the control device controls, regarding a portion having a lower solvent content in a width direction of the self-supporting film than a predetermined solvent content, an amount of extrusion of the polyimide precursor solution from a die portion corresponding to the portion having the lower solvent content in the extrusion device so as to increase the amount of extrusion.

13. An apparatus for the production of a polyimide film according to claim 9, the apparatus further comprising thickness measurement means for measuring a thickness of the cast oldie polyimide precursor solution, wherein the extrusion condition of the extrusion device is also controlled based on a measurement result of the thickness measurement means.
